(19) United States
(12) Patent Application Publication
(10) Pub. No.: US 2025/0237895 A1
(43) Pub. Date: Jul. 24, 2025

(54) BALANCED DIFFERENTIAL MODULATION SCHEMES FOR SILICON PHOTONIC MODULATORS

(71) Applicant: ADVANCED MICRO FOUNDRY PTE. LTD., Singapore (SG)

(72) Inventors: Shawn Yohanes SIEW, Singapore (SG); Xianshu LUO, Singapore (SG); Qiang LI, Singapore (SG); Salih YANIKGONUL, Singapore (SG)

(73) Assignee: ADVANCED MICRO FOUNDRY PTE. LTD., Singapore (SG)

(21) Appl. No.: 18/853,483

(22) PCT Filed: May 6, 2022
(86) PCT No.: PCT/SG2022/050283

§ 371 Date: Oct. 2, 2024

(51) Int. Cl. G02F 1/015; G02F 1/01; G02F 1/21

(52) U.S. Cl. CPC G02F 1/015; G02F 1/0121; G02F 1/212; G02F 2201/126; G02F 2202/10

(57) ABSTRACT

The invention relates to photonic differential modulators and more particularly different electrode configurations for differential driving schemes for reducing the driving voltage for a given phase shift and device footprint. The embodiments comprise of two reverse-biased p-n junctions driven in a push-pull configuration from signal (S) to signal bar (S-bar). The first embodiment shares the S-bar electrode between two p-n junctions to reduce the device footprint at the expense of difficult impedance matching. The second embodiment does not contain any shared electrode and instead adds additional electrodes for the sake of easier impedance matching. Specifically, the second embodiment decouples the two p-n junctions along with their respective transmission lines for ease of impedance matching. The third embodiment shares both the S and S-bar electrodes through an interleaved electrode design to reduce the device footprint, and makes impedance matching easier by slow-wave effect on the transmission lines.

### FIELD OF THE INVENTION

The present invention relates to a field of silicon photonics and various modulators and more particularly differential modulation schemes for balanced silicon photonic modulators.

### BACKGROUND OF THE INVENTION

The power consumption in communication networks increases as the data rate ramps up. One way to reduce the power consumption is to reduce the driving voltage of the electro-optic modulators used in optical communication networks. Specifically, driving silicon photonic modulators with high modulation efficiency (i.e., low driving voltage) in a compact footprint is an ongoing effort.

Document US 2019/0162987 A1 provides a compact structure where the device length is effectively reduced by meandering the waveguide geometry. However, matching the group velocities of the optical field and the modulating microwave field is difficult to achieve in this device geometry; therefore, the electro-optic bandwidth of the modulator would be limited.

Document U.S. Pat. No. 9,507,237B2 proposes a differential modulation scheme for driving silicon-based Mach-Zehnder modulators (MZM), whose operation relies on the modulation of optical interference through optical phase change induced by free-carrier plasma dispersion effect. However, the proposed driving schemes requires many electrodes.

An ideal MZM should possess high electro-optic bandwidth, high efficiency (i.e., low driving voltage), low insertion loss, compact footprint, and operational stability to name a few. However, the prior art still lacks an electro-optic modulator driving scheme that achieves modulation with small driving voltage in a compact footprint.

### SUMMARY OF THE INVENTION

In one embodiment, the invention relates to a photonic differential modulator, wherein the modulator comprises two p-n junction diodes connected to at least one signal electrode (S) and at least one signal bar electrode (S̅), which refers to a signal electrode driven by the complementary inverted signal, configured in a push-pull driving scheme. In one of these junctions, the p-doped and n-doped side are connected to S and S-bar electrodes, respectively. In the other junction, the p-doped and n-doped side are connected to S-bar and S electrodes, respectively. These two junctions share the S-bar electrode at their respective parts. Both p-n junction diodes are reverse biased either via on-chip biasing or externally via bias tees. The DC bias configuration is not shown here for the sake of simplicity and beyond the scope of this embodiment.

In one embodiment of photonic differential modulator, the modulator further comprises two or more ground electrodes (G), which can be used for electro-magnetic isolation of the driving RF field.

In one embodiment of photonic differential modulator, the modulator further comprises GSS̅SG electrode structure.

In one embodiment of photonic differential modulator, the driving voltage for a given phase shift is halved by driving each p-n junction from S to S-bar and vice versa in a push-pull configuration compared to the conventional differential driving scheme where each p-n junction is driven from S or S-bar to ground.

In another embodiment, the photonic differential modulator comprises two p-n junction diodes connected to at least one signal electrode (S) and at least one signal bar electrode (S-bar) configured in a push-pull driving scheme. In one of these junctions, the p-doped and n-doped side of p-n junction are connected to S and S-bar electrodes, respectively. In the other junction, the p-doped and n-doped side of p-n junction are connected to S-bar and S electrodes, respectively. Compared to the embodiment previously described, these two junctions do not share the S-bar electrode. Each have their own independent S and S-bar electrodes, respectively, with a ground electrode in between. Thus, the two p-n junction diodes decoupled from their respective transmission lines from each other by the additional S, S-bar, and ground electrodes for easier impedance matching at the cost of increased footprint. Likewise, both p-n junctions are reverse biased either via on-chip biasing or externally via bias tees.

In one embodiment of photonic differential modulator, the modulator further comprises three or more ground electrodes (G), which can be used for electro-magnetic isolation of the driving RF field.

In one embodiment of the photonic differential modulator, the modulator comprises GSS̅GSS̅G electrode structure.

In one embodiment of photonic differential modulator, the driving voltage for a given phase shift is halved by driving each p-n junction from S to S-bar and vice versa in a push-pull configuration compared to the conventional differential driving scheme where each p-n junction is driven from S or S-bar to ground.

In another embodiment, the photonic differential modulator as described above comprises two p-n junction diodes connected to at least one signal electrode and at least one signal bar electrode configured in a push-pull driving scheme. Similar to the previous embodiments, the p-doped and n-doped side in one of these junctions are connected to S and S-bar electrodes, respectively. In the other junction, the p-doped and n-doped side are connected to S-bar and S electrodes, respectively. These two junctions share both the S and S-bar electrodes in their respective parts through interleaved electrode structure so that the design mitigates the need for additional electrodes and saves from the device footprint. Likewise, both p-n junctions are reverse biased either via on-chip biasing or externally via bias tees.

In another embodiment, the invention relates to a photonic differential modulator with interleaved electrode design to provide modulation with low driving voltage in a compact footprint.

In one embodiment of photonic differential modulator, the modulator further comprises two or more ground electrodes (G), which can be used for electro-magnetic isolation of the driving RF field.

In one embodiment of the photonic differential modulator, the modulator comprises GSS̅G electrode structure.

In one embodiment of photonic differential modulator, the driving voltage for a given phase shift is halved by driving each p-n junction from S to S-bar and vice versa in a push-pull configuration compared to the conventional differential driving scheme where each p-n junction is driven from S or S-bar to ground.

In one embodiment, the invention relates to a photonic differential modulator as described above, wherein the material is selected from silicon, lithium niobate (LN), barium titanate (BTO), III-V materials (e.g., InP, GaAs, InGaAs, InGaAsP), and EO-polymers.

### BRIEF DESCRIPTION OF THE DRAWINGS

Other objects, features, and advantages of the embodiment will be apparent from the following description when read with reference to the accompanying drawings. In the drawings, wherein like reference numerals denote corresponding parts throughout the several views:

The diagrams are for illustration only, which thus is not a limitation of the present disclosure, and wherein:

FIG. 1a illustrates the cross-sectional view of a first photonic differential modulator design 100, according to an embodiment herein;

FIG. 1b illustrates the top view of a first photonic differential modulator design 100, according to an embodiment herein;

FIG. 2a illustrates the cross-sectional view of the second photonic differential modulator design 200, according to an embodiment herein;

FIG. 2b illustrates the top view of the second photonic differential modulator design 200, according to an embodiment herein;

FIG. 3a illustrates the cross-sectional view of the third photonic differential modulator design 300, according to an embodiment herein.

FIG. 3b illustrates the top view of the third photonic differential modulator design 300, according to an embodiment herein.

To facilitate understanding, like reference numerals have been used, where possible to designate like elements common to the figures.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The embodiments used herein are intended merely to facilitate an understanding of ways in which the embodiments herein may be practiced and to further enable those of skill in the art to practice the embodiments herein. Accordingly, the examples should not be construed as limiting the scope of the embodiments herein.

Throughout the prior art, there remains a need for advanced differential modulation schemes where low driving voltage can be achieved in a compact footprint.

The invention provides a photonic differential modulator comprising two p-n junction diodes connected to at least one signal electrode (S) and at least one signal bar electrode (S-bar). The p-n junction diodes are reverse-biased. The S and S-bar electrodes are connected to the junctions in a way that the two junctions operate in a push-pull configuration. The p-dope d and n-doped side of one p-n junction are connected to S- and S-bar electrodes, respectively. The p-doped and n-doped side of the other p-n junction are connected to S-bar and S electrodes, respectively. The S-bar electrode is shared between these two junctions, which are reverse biased via on-chip biasing or externally via bias tees.

In an embodiment, the modulation principle is based on the Mach-Zehnder interferometer modulator (MZM). An MZM is used to control the amplitude of an optical wave and its operation principle is as follows. First, the input light is split into two optical paths. Next, a phase shift is induced between the optical waves propagating in these two paths. Finally, these two beams are recombined together so that the relative phase shift is converted to amplitude modulation due to the wave interference.

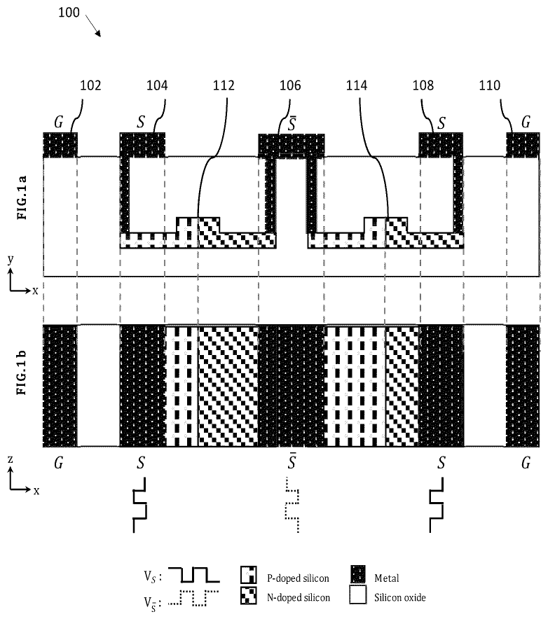

Referring to FIGS. 1a and 1b, a first photonic differential modulator design 100 in accordance with the embodiment of the present invention is provided with a GSS̅SG electrode design.

The first photonic differential modulator design 100 includes a first ground electrode 102, a first signal electrode S 104, a signal bar electrode (S-bar) 106, a second signal electrode S 108, a second ground electrode 110, a reverse-biased p-n junction diode 112, another reverse biased p-n junction diode 114.

The first photonic differential modulator design 100 includes a first S electrode 104 that is connected to the p-doped side of the p-n junction diode 112. Furthermore, the n-doped side of this p-n junction diode 112 is connected to the S-bar electrode 106. The S-bar electrode 106 is further connected to the p-doped side of the other p-n junction diode 114. Furthermore, the n-doped side of this p-n junction diode 114 is connected to the second S electrode 108. The ground electrodes 102 and 110 are optional and can be used to improve the electromagnetic isolation of the driving RF field.

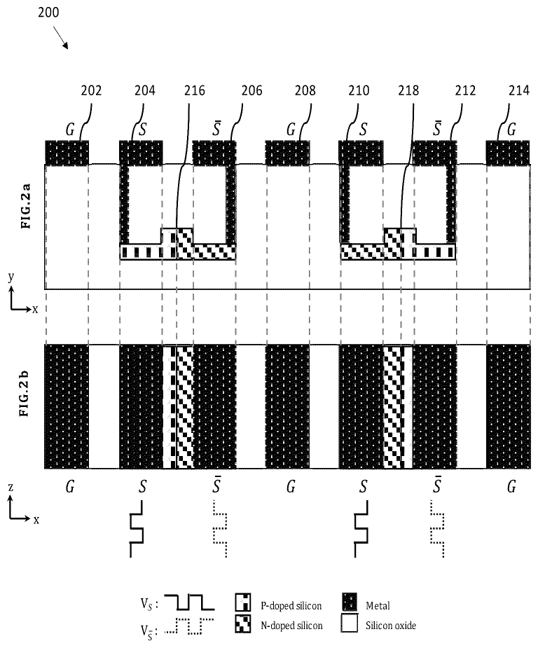

Referring to FIGS. 2a and 2b, a second photonic differential modulator design 200 in accordance with the embodiment of the present invention is provided.

In an embodiment, to overcome the challenge of matching 3 signal lines (104, 106, and 108) to a practical characteristic impedance (e.g., 100 ohm), the circuit 200 with GSS̅GSS̅G is described in the context.

The second photonic differential modulator design 200 includes a first ground electrode 202, a first signal electrode 204, a first signal bar electrode (S-bar) 206, a second ground electrode 208, a second signal electrode 210, a second signal bar electrode (S-bar) 212, a third ground electrode 214, a reverse-biased p-n junction diode 216, and another reverse-biased p-n junction diode 218.

In the second photonic differential modulator design 200, the first S electrode 204 is connected to the p-doped side of the p-n junction diode 216. The n-doped side of this p-n junction diode 216 is connected with the first S-bar electrode 206. The n-doped side of the p-n junction diode 218 is connected with the second S electrode 210 and the p-doped side of this p-n junction diode 218 is connected with the second S-bar electrode 212. The grounded electrodes 202, 208, and 214 are optional and can be used to improve the electromagnetic isolation of the RF field.

The S and S-bar electrodes are travelling-wave electrodes whose characteristic impedance needs to be matched to the impedance of the driver and to the RF terminator. Otherwise, the impedance mismatch causes the reflection of the modulating RF field and might eventually lead to inter-symbol interference (ISI) and degradation of the electro-optic bandwidth of the modulator. The impedance matching of the S and S-bar electrodes in the first embodiment 100 to a practical characteristic impedance value (e.g., 100 ohm) is challenging because the shared S-bar electrode 106 limits the freedom for tuning the design parameters (e.g., electrode width, separation, and thickness) for achieving impedance matching. The second embodiment 200, however, decouples these two p-n junctions from each other by omitting the shared S-bar electrode in between and adding additional electrodes instead; this brings the advantage of easier impedance matching of the travelling-wave electrodes, yet at the cost of larger footprint.

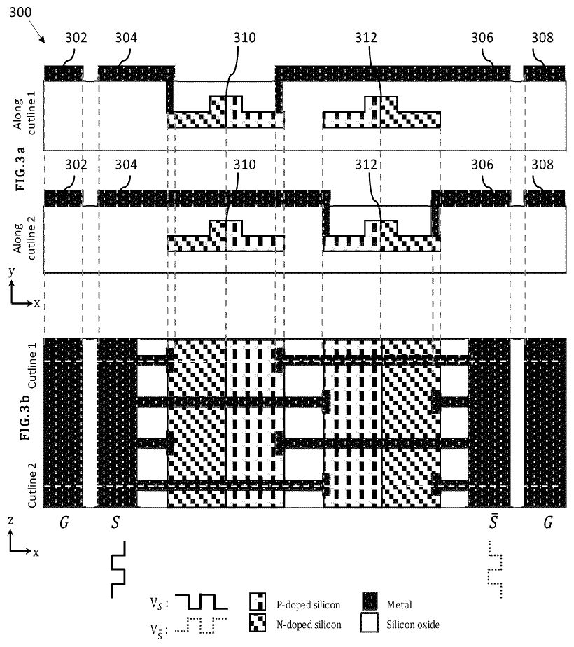

Referring to FIGS. 3a and 3b, a third differential modulator design 300 in accordance with the embodiment of the present invention is provided with a GSS̅G design.

The third photonic differential modulator design 300 includes a first ground electrode 302, a signal electrode 304, a signal bar electrode (S-bar) 306, and a second ground electrode 308, a reverse-biased p-n junction diode 310, and another reverse-biased p-n junction diode 312.

The third photonic differential modulator design 300 includes a first ground electrode 302 and a second ground electrode 308. The S electrode 304 is connected to the n-doped side of the p-n junction diode 310. The S-bar electrode 306 is connected to the p-doped side of this p-n junction diode 310. The signal electrode 304 is further connected to the p-doped side of the p-n junction diode 312. The S-bar electrode 306 is also connected to the n-doped side of the p-n junction diode 312. The grounded electrodes 302 and 308 are optional and can be used to improve the electromagnetic isolation of the RF field. Unlike the previous embodiments, here the S electrode 304 and S-bar electrode 306 are both interleaved and shared by these two p-n junctions 310 and 312.

In an embodiment, the interleaving electrode structure shown in FIGS. 3a and 3b is utilized to achieve the differential driving scheme introduced in previous embodiments but in a much more compact footprint while retaining ease of impedance matching. Here, the interleaved electrode configuration mitigates the need for accommodating more electrodes as in the embodiment 200.

The term “interleaved” in the context of the invention refers to the layout of the S electrode 304 and S-bar electrode 306 and does not refer to the connection to the p-n junctions underneath. The interleaved electrode structure makes the impedance matching of the transmission line easier due to slow-wave effect compared to the first photonic differential modulator 100. The interleaved electrode structure reduces the required number of electrodes for the differential driving scheme compared to the photonic differential modulator 200.

In another embodiment, the third photonic differential modulator design 300 reduces the footprint as the electrode configuration is changed from the GSS̅GSS̅G to GSS̅G electrode scheme. Since the device footprint roughly scales with the number of electrodes, a GS electrode configuration occupies around half the area that a GSS̅G electrode does.

In one embodiment, the material to fabricate the photonic differential modulator is selected from silicon, lithium niobate (LN), barium titanate (BTO), III-V materials (e.g., InP, GaAs, InGaAs, InGaAsP), and EO-polymers.

The characteristic impedance Z₀ of a lossless transmission line can be described as Z₀=\sqrt{L/C}, where L and C denote the impedance and the capacitance of the transmission line. The microwave index n_{μ} can be described as n_{μ}=c₀\sqrt{L/C}, where c₀ is the speed of light in vacuum. In an embodiment, the interleaved electrode structure increases the inductance L of the transmission line and eases the matching of the characteristic impedance Z₀. However, this comes at the cost of increased microwave index n_{μ}, which results in a slower microwave group velocity than the optical group velocity, reducing the electro-optic bandwidth of the modulator.

In all the embodiments, the reverse-biased p-n junctions are driven from S to S-bar, which improves the modulation efficiency by two times compared to the conventional differential driving schemes that drive from S or S-bar to ground and by four times compared to the single-ended driving schemes that drive from S to ground.

A comparison table for design and performance metrics of the conventional series-push-pull (SPP) modulator, conventional differential modulator, and our inventive embodiments 100, 200, and 300 is provided below.

TABLE-1

| | Conventional | Conventional | Embodiment | Embodiment | Embodiment |
|---|---|---|---|---|---|
| | SPP | Differential | #1 (100) | #2 (200) | #3 (300) |
| Electrode | GS | GSGSG | GSSSG | GSSGSSG | GSSG |
| configuration | | | | | |
| Footprint | A | 2.5A | 2.5A | 3.5A | 2A |
| Driving voltage | V | V/2 | V/4 | V/4 | V/4 |
| Impedance | Easy | Easy | Difficult | Easy | Easy |
| matching | | | | | |
| Design | Easy | Easy | Easy | Easy | Difficult |
| complexity | | | | | |

From the Table 1, it is noted that the driving voltages of embodiments #1 (100), #2 (200) and #3 (300) are lower than the conventional driving schemes. Each of these embodiments brings their own design and performance trade-offs and can cater to various application requirements.

As will be readily apparent to those skilled in the art, the present embodiment may easily be produced in other specific forms without departing from its essential characteristics.

The present embodiments are, therefore, to be considered as merely illustrative and not restrictive, the scope being indicated by the claims rather than the foregoing description, and all changes which come within therefore intended to be embraced therein.

1. A photonic differential modulator comprising;
two p-n junction diodes connected to at least one signal electrode (S) and a signal bar electrode (S-bar or S̅) configured in a push-pull driving scheme;
wherein p-doped and n-doped side of one p-n junction are connected to S- and S-bar electrodes, respectively,
wherein the S-bar electrode is shared between the two p-n junction diodes,
wherein a driving voltage for a given phase shift is halved by driving each p-n junction from S to S-bar and vice versa in a push-pull configuration compared to a conventional differential driving scheme where each p-n junction of the conventional differential driving scheme is driven from S or S-bar to ground,
wherein the p-doped and n-doped side of other p-n junction are connected to S-bar and S electrodes, respectively, and
wherein the two p-n junction diodes are reverse-biased.

2-3. (canceled)

4. The photonic differential modulator as claimed in claim 1, further comprises two or more ground electrodes (G).

5. The photonic differential modulator as claimed in claim 4, wherein the modulator comprises GSS̅SG electrode structure.

6. (canceled)

7. A photonic differential modulator comprising:
two p-n junction diodes connected to at least one signal electrode (S) and at least one signal bar electrode (S-bar or S̅) configured in a push-pull driving scheme;
wherein the two p-n junction diodes are reverse-biased;
wherein the modulator comprises GSS̅GSS̅G electrode structure wherein G is ground electrode,
wherein a driving voltage for a given phase shift is halved by driving each p-n junction from S to S-bar and vice versa in a push-pull configuration compared to a conventional differential driving scheme where each p-n junction of the conventional differential driving scheme is driven from S or S-bar to ground,
wherein p-doped and n-doped side of one p-n junction are connected to S- and S-bar electrodes, respectively, and
wherein the p-doped and n-doped side of other p-n junction are connected to S-bar and S electrodes, respectively,
wherein the two p-n junction diodes are decoupled from their respective transmission lines from each other by the S, S-bar, and ground electrodes for easier impedance matching at cost of increased footprint.

8-11. (canceled)

12. A photonic differential modulator comprising;
electrode structure GSS̅G wherein G is ground electrode;
two p-n junction diodes connected to a signal electrode (S) and a signal bar electrode (S-bar or S̅) configured in a push-pull driving scheme;
wherein p-doped and n-doped side of one p-n junction are connected to S- and S-bar electrodes, respectively,
wherein the two p-n junction diodes are reverse-biased,
wherein a driving voltage for a given phase shift is halved by driving each p-n junction from S to S-bar and vice versa in a push-pull configuration compared to a conventional differential driving scheme where each p-n junction of the conventional differential driving scheme is driven from S or S-bar to ground,
wherein the p-doped and n-doped side of other p-n junction are connected to S-bar and S electrodes, respectively, and
wherein the S and S-bar electrodes are shared between the two p-n junction diodes; wherein the S and S-bar electrodes have interleaved electrode structure.

13-16. (canceled)

17. The photonic differential modulator as claimed in claim 1 is fabricated from materials selected from silicon, lithium niobate (LN), barium titanate (BTO), III-V materials, and EO-polymers.

18. The photonic differential modulator as claimed in claim 4 is fabricated from materials selected from silicon, lithium niobate (LN), barium titanate (BTO), III-V materials, and EO-polymers.

19. The photonic differential modulator as claimed in claim 5 is fabricated from materials selected from silicon, lithium niobate (LN), barium titanate (BTO), III-V materials (e.g., InP, GaAs, InGaAs, InGaAsP), and EO-polymers.

20. The photonic differential modulator as claimed in claim 7 is fabricated from materials selected from silicon, lithium niobate (LN), barium titanate (BTO), III-V materials (e.g., InP, GaAs, InGaAs, InGaAsP), and EO-polymers.

21. The photonic differential modulator as claimed in claim 12 is fabricated from materials selected from silicon, lithium niobate (LN), barium titanate (BTO), III-V materials (e.g., InP, GaAs, InGaAs, InGaAsP), and EO-polymers.
